(19) United States
(12) Patent Application Publication
(10) Pub. No.: US 2020/0280105 A1
(43) Pub. Date: Sep. 3, 2020

(54) SECONDARY ELECTROCHEMICAL CELL HAVING A ZINC METAL NEGATIVE ELECTRODE AND MILD AQUEOUS ELECTROLYTE AND METHODS THEREOF

(71) Applicant: Salient Energy Inc., Dartmouth (CA)

(72) Inventors: Brian D. ADAMS, Dartmouth (CA); Joon H. Ahn, Toronto (CA); Ryan D. Brown, Cambridge (CA); Robert D. Clarke, Plattsville (CA); Marine B. Cuisinier, Dartmouth (CA); John Philip S. Lee, Waterloo (CA)

(21) Appl. No.: 16/759,934

(22) PCT Filed: Nov. 19, 2018
(86) PCT No.: PCT/CA2018/051466

§ 371 Date: Apr. 28, 2020

Related U.S. Application Data
(60) Provisional application No. 62/587,715, filed on Nov. 17, 2017.

(51) Int. Cl. H01M 10/26; H01M 2/16; H01M 4/24; H01M 4/26; H01M 4/04; H01M 10/28

(52) U.S. Cl. CPC H01M 10/26; H01M 2/162; H01M 2/1646; H01M 4/244; H01M 2004/027; H01M 4/0404; H01M 4/0435; H01M 4/0409; H01M 10/28; H01M 4/26

(57) ABSTRACT

Provided is a secondary electrochemical cell for storing and delivery electrical energy and method of forming same. The secondary electrochemical cell includes: a thin film zinc metal negative electrode comprising a negative electrode current collector and a zinc metal layer applied to the negative electrode current collector; a thin film positive electrode comprising a positive electrode current collector and an active material layer applied to the positive electrode current collector, wherein the active material layer electrochemically reacts reversibly with Zn2+ cations; an aqueous electrolyte ionically coupling the negative electrode to the positive electrode; and a thin separator disposed between the negative electrode and the positive electrode, wherein the separator is wetted by the aqueous electrolyte.

### TECHNICAL FIELD

The following relates generally to secondary electrochemical cells, and more particularly to secondary electrochemical cells using metallic zinc as the negative electrode.

### INTRODUCTION

Metallic zinc negative electrodes are used in many primary (non-rechargeable) and secondary (rechargeable) aqueous battery types. Zinc is inexpensive, non-toxic, has a low redox potential (−0.76 V vs. standard hydrogen electrode) compared to other negative electrode materials used in aqueous batteries, and is stable in water due to a high overpotential for hydrogen evolution.

Electrochemical cells employing zinc metal have been used in commercial applications. Several traditional and modern types of batteries using zinc metal electrodes are listed in FIG. 1, along with the internal cell chemistry in standard cell notation. The alkaline (Zn∥MnO₂), zinc-air (Zn∥O₂), and Ni—Zn (Zn∥NiOOH) are being commercialized as rechargeable batteries. Each of these uses an alkaline electrolyte, most commonly based on a high concentration of NaOH or KOH. Rechargeability of these cells is limited due to a tendency of zinc to form dendrites in an alkaline electrolyte during recharge of the cell (Zn plating). These dendrites can grow from the negative electrode to the positive electrode and result in the cell experiencing an internal short circuit.

TABLE 1
Zinc battery types.

| Battery Type | Cell Chemistry |
|---|---|
| Alkaline | Zn(s)\|ZnO(s)\|OH⁻(aq)\|\|OH⁻(aq)\|MnO₂(s)\|MnO(OH)(s)\|C(s) |
| Bunsen | Zn(s)\|H₂SO₄(aq), ZnSO₄(aq)\|\|NO₂(g)\|HNO₃(aq)\|C(s) |
| Chromic Acid | Zn(s)\|H₂SO₄(aq), H₂CrO₄(aq)\|C(s) |
| Daniell | Zn(s)\|ZnSO₄(aq)\|\|CuSO₄(aq)\|Cu(s) |
| Zinc-carbon | Zn(s)\|ZnCl₂(aq)\|\|NH₄Cl(aq)\|NH₃(aq)\|MnO₂(s)\|MnO(OH)(s)\|C(s) |
| (Leclanche) | |
| Grove | Zn(s)\|H₂SO₄(aq), ZnSO₄(aq)\|\|NO₂(g)\|HNO₃(aq)\|Pt(s) |
| Mercury-Oxide | Zn(s)\|ZnO(s)\|OH⁻(aq)\|\|OH⁻(aq)\|HgO(s)\|Hg(s) |
| Nickel-Zinc | Zn(s)\|ZnO(s)\|OH⁻(aq)\|\|OH⁻(aq)\|Ni(OH₂)(s)\|NiOOH(s)\|MnO₂(s)\|MnO(OH)(s)\|C(s) |
| Pulvermacher's | Zn(s)\|vinegar(aq)\|\|vinegar(aq)\|Cu(s) |
| Chain | |
| Volta Pile | Zn(s)\|Cl⁻(aq)\|\|Cl⁻(aq)\|Cu(s) |
| Zinc-air | Zn(s)\|ZnO(s)\|OH₋(aq)\|\|OH₋(aq)\|O₂(g) |
| Zinc-chloride | Zn(s)\|ZnCl₂(aq)\|\|ZnCl₂(aq)\|MnO₂(s)\|MnO(OH)(s)\|C(s) |

Drawbacks and challenges for secondary cells using zinc negative electrodes are the formation of dendritic or mossy deposits and low coulombic efficiency of plating/stripping cycles. The uncontrolled deposition of zinc can form build-ups during repeated cycling and cause premature cell failure by internal short circuits. The low coulombic efficiency limits the cycle life by consumption of active zinc metal through side reactions or formation of inactive “dead” zinc inside the cell. Generally, a higher coulombic efficiency for zinc metal stripping/plating allows for a lower excess of zinc to be present in the negative electrode to achieve the same number of cycles in a battery.

Zinc electrodes in alkaline electrolytes are particularly prone to dendritic zinc formation and low coulombic efficiency (typically <85%). Some battery chemistries using zinc metal electrodes can make use of neutral or acidic electrolytes such as zinc-ion systems relying on intercalation/deintercalation of Zn²⁺ at the positive electrode. Rather than the dissolution/precipitation reaction at the zinc electrode in alkaline electrolytes (Zn+4OH⁻↔Zn(OH)₄²⁻+2e⁻ and Zn(OH)₄²⁻↔ZnO+2OH⁻+H₂O), the reaction mechanism in acidic electrolytes (Zn↔Zn²⁺+2e⁻) does not involve insulating zinc oxide. This advantage leads to much higher coulombic efficiencies, often greater than 95%. However, strongly acidic electrolytes pose additional challenges, such as enhanced hydrogen evolution (HER: 2H⁺+e⁻→H₂) during charge of a battery and corrosion of cell casings, current collectors, and dissolution of active battery materials.

U.S. Pat. No. 6,187,475 to Ahanyang Seung-Mo Oh and Kunpo Sa-Heum Kim describes a zinc-ion battery using a mild, near-neutral pH aqueous electrolyte. However, this battery is capable of achieving only 120 cycles.

Accordingly, there is a need for a secondary electrochemical cell having a zinc metal negative electrode that overcomes at least some of the deficiencies of conventional zinc and non-zinc secondary cells.

### SUMMARY

According to some embodiments, there is a secondary electrochemical cell for storing and delivering electrical energy including a thin film zinc metal negative electrode having a negative electrode current collector and a zinc metal layer applied to the negative electrode current collector, a thin film positive electrode having a positive electrode current collector and an active material layer applied to the positive electrode current collector, wherein the active material layer electrochemically reacts reversibly with Zn²⁺ cations, an aqueous electrolyte ionically coupling the negative electrode to the positive electrode, and a thin separator disposed between the negative electrode and the positive electrode, wherein the separator is wetted by the aqueous electrolyte.

In an aspect, the zinc metal layer has an areal capacity greater than an areal capacity of the positive electrode.

In another aspect, the thin film zinc metal negative electrode has a first face and a second face, and the areal capacity of the zinc metal layer is greater than or equal to 1 mAh/cm² on each of the first face and the second face of the negative electrode.

In another aspect, the aqueous electrolyte has a pH value between 4 and 6.

In another aspect, the aqueous electrolyte includes a gelling agent for increasing the viscosity of the aqueous electrolyte.

In another aspect, the thin separator has a thickness less than or equal to 200 μm.

In another aspect, the thin separator includes an electrically insulating woven or non-woven material wetted by the aqueous electrolyte.

In a further aspect, the thin separator includes ceramic or glass particles embedded in a polymeric matrix of textile fibers.

In another aspect, the thin film positive electrode has a first face and a second face, and wherein the storage capacity per electrode area is between 1 mAh/cm² and 10 mAh/cm² on each of the first face and the second face of the positive electrode.

According to some embodiments, there is a method of forming a secondary electrochemical cell including providing a thin film zinc metal negative electrode and a thin film positive electrode, the thin film zinc metal negative electrode including a negative electrode current collector and a zinc metal layer applied to the negative electrode current collector, the thin film positive electrode including a positive electrode current collector and an active material layer applied to the positive electrode current collector, wherein the active material layer electrochemically reacts reversibly with Zn²⁺ cations, ionically coupling the negative electrode to the positive electrode via an aqueous electrolyte, and disposing a thin separator between the negative electrode and the physical electrode, wherein the thin separator is wetted by the aqueous electrolyte.

In an aspect, the zinc metal layer has an areal capacity greater than an areal capacity of the positive electrode.

In another aspect, the thin film zinc metal negative electrode has a first face and a second face, and the areal capacity of the zinc metal layer is greater than or equal to 1 mAh/cm² on each of the first face and the second face of the negative electrode.

In another aspect, the aqueous electrolyte has a pH value between 4 and 6.

In another aspect, the aqueous electrolyte includes a gelling agent for increasing the viscosity of the aqueous electrolyte.

In another aspect, the thin separator has a thickness less than or equal to 200 μm.

In another aspect, the thin separator includes an electrically insulating woven or non-woven material wetted by the aqueous electrolyte.

In a further aspect, the thin separator includes ceramic or glass particles embedded in a polymeric matrix of textile fibers.

In another aspect, the thin film positive electrode has a first face and a second face, and wherein the storage capacity per electrode area is between 1 mAh/cm² and 10 mAh/cm² on each of the first face and the second face of the positive electrode.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a side view of a zinc metal secondary cell, according to an embodiment;

FIG. 2A is a cross-section view of a first embodiment of a cell of the zinc metal secondary cell of FIG. 1;

FIG. 2B is a cross-section view of a second embodiment of a cell of the zinc metal secondary cell of FIG. 1;

FIG. 2C is a cross-section view of a third embodiment of a cell of the zinc metal secondary cell of FIG. 1;

FIG. 3 is a graph illustrating the cycle life of zinc metal before failure due to internal short circuits in Zn∥Ti cells, according to an embodiment;

FIG. 4 is a graph illustrating the results of Zn∥Zn symmetric cells used to test different electrolyte gel forming agents for plating and stripping of zinc metal electrodes, according to an example;

FIG. 5 is a graph illustrating the voltage profile for the first cycle of a thin film electrode and a thick electrode both cycled at 0.6 mA/cm² in 1 M ZnSO₄+0.1 M MnSO₄ dissolved in water electrolyte, according to an example;

FIG. 6 is a graph illustrating the cycling performance for the two Zn∥EMD cells of FIG. 5, represented by their areal capacity (mAh/cm²) as a function of the cycle number;

FIG. 7 is a graphical representation of an exemplary first cycle for a cell prepared using a zinc metal negative electrode (Zn foil=30 μm), a separator of paper (160 μm) soaked in an electrolyte of 1 M ZnSO₄/water, and a positive electrode made from an active coating of Zn_{0.25}V₂O₅.nH₂O on a roughened Ni foil current collector (15 μm);

FIG. 8 is a graphical representation of an exemplary first cycle for a cell having a zinc negative electrode.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

To ensure a long cycle life, a secondary battery using a zinc metal negative electrode requires high reversibility of zinc stripping and plating cycles. In addition, to maximize the practical gravimetric and volumetric energy density of a secondary battery, the amount of active materials should be maximized, while at the same time, minimizing the amount of inactive components. For example, the areal capacity of the positive electrode is matched by the capacity of the zinc negative electrode, and the excess amount of zinc metal should be minimized. Excess zinc metal is considered an inactive component. Other inactive components include negative and positive electrode current collectors and separators.

The present disclosure relates generally to improving the cycle life of secondary electrochemical cells with zinc metal negative electrodes in a mild (pH˜4 to ˜6) aqueous electrolyte. Any one or more of the choice of separator material, the thickness of the separator, the use of a gelled electrolyte, and the limitation of the amount of zinc plated and stripped during each charge/discharge cycle can extend the cycle life of secondary electrochemical cells. “Cycle life” as used herein refers to the number of times a secondary cell can be discharged and charged before the secondary electrochemical cell stores 80% of its initial capacity.

As used herein, the term “about”, when used in reference to a pH value, means the pH value given +/−0.5, unless otherwise stated. When the term “about” is used in reference to a pH range, it is understood that the forgoing definition of “about” is to be applied to both the lower limit and upper limit of the range.

As used herein, the term “about”, when used in reference to a molar concentration (“molar”) value, means the molar value +/−0.1 molar, unless otherwise stated. When the term “about” is used in reference to a molar range, it is understood that the forgoing definition of “about” is to be applied to both the lower limit and upper limit of the range.

As used herein, the term “between”, when used in reference to a range of values such as a molar range or a pH range, means the range inclusive of the lower limit value and upper limit value, unless otherwise stated. For example, a pH range of “between 4 to 6” is taken to include pH values of 4.0 and 6.0.

The present disclosure describes a zinc-ion battery design that is easy to manufacture and/or that extends the cycle life of zinc-ion batteries into the several hundred or thousands of cycles. The design of the zinc-ion battery may affect the plating and stripping of zinc during battery cycling and, consequently, affect the cycle life.

For each of the negative and positive electrodes, the use of a metal foil as a current collector having a relatively thin coating of electrochemically active material may provide the zinc-ion battery designs to be easy to manufacture. The thin film coating may allow for electrodes to be manufactured using similar methods to those employed in the manufacture of lithium-ion battery electrodes. Further, the electrodes described herein may be flexible enough to be assembled into cell formats commonly employed by lithium-ion batteries.

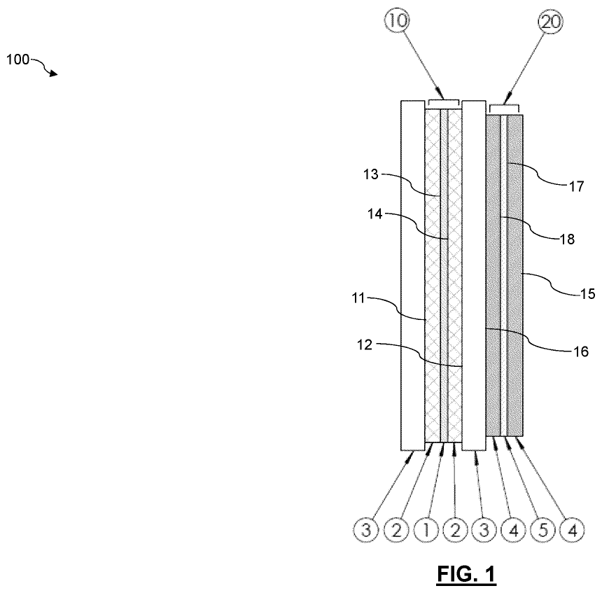

Referring now to FIG. 1, shown therein is a secondary electrochemical cell 100, according to an embodiment. The cell 100 can be used for the storage and delivery of electrical energy.

The secondary cell 100 includes a thin film zinc metal negative electrode 10, an aqueous electrolyte, a thin film positive electrode 20, and a thin separator 3. The cell 100 may be in a thin film electrode stack configuration.

The negative electrode 10 is a thin film zinc metal electrode. The thin film zinc metal electrode may have a thickness (thickness value) on the order of microns. The negative electrode 10 includes a first face 11 and a second face 12. The negative electrode 10 includes a zinc metal layer 2. The areal capacity of the zinc metal layer 2 may be greater than the areal capacity of the positive electrode 20. The areal capacity of the zinc metal layer 2 may be greater than 1 mAh/cm² on each face 11, 12 of the negative electrode 10.

The negative electrode 10 includes a current collector 1 for collecting current. The current collector 1 may be less than 50 μm thick. The current collector 1 includes a first face 13 and a second face 14. The zinc metal layer 2 is adhered to the first face 13 and the second face 14 of the current collector 1. The current collector 1 may be an electrically conductive metal foil.

In an embodiment, the negative electrode 10 may be formed using a slurry casting or rolling of a paste or dough containing zinc metal onto a metal foil substrate (current collector 1).

The positive electrode 20 is a thin film positive electrode. The thin film positive electrode may have a thickness on the order of microns. The positive electrode 20 includes a first face 15 and a second face 16.

The positive electrode 20 reacts reversibly with Zn²⁺ cations. The positive electrode 20 includes an active material 4 that electrochemically reacts with Zn²⁺ in the electrolyte in a reversible manner. “Reversible” refers to the ability to recover at least 90% of electrical charge stored in the material upon charging the cell 100. The amount of active material 4 on the positive electrode may be limited such that the storage capacity per electrode area is between 1 mAh/cm² and 10 mAh/cm² on each face 15, 16 of the positive electrode 20.

The positive electrode 20 includes a current collector 5 for collecting current. The current collector 5 includes a metal substrate. The current collector 5 includes a first face 17 and a second face 18. The current collector 5 may be coated on the first and second faces 17, 18 with a mixture including an electrochemically active material, a conductive additive, and a binder. The current collector 5 of the positive electrode 20 may be a metal foil. The current collector 5 may be less than 50 μm thick.

In an embodiment, the positive electrode 20 may be formed using a slurry casting or rolling of a paste or dough containing active material 4 onto a metal foil substrate (current collector 5).

The aqueous electrolyte ionically couples the negative electrode 10 to the positive electrode 20. The pH of the electrolyte may be between about 4 and 6.

The electrolyte may include a zinc salt dissolved in water. The zinc salt may be dissolved so that zinc ions are present in the electrolyte in a range from about 0.001 molar to 10 molar. The zinc salt may be dissolved so that zinc ions are present in the electrolyte in a range from about 0.1 molar to about 4 molar. The zinc salt may be selected from a group of zinc salts including zinc sulfate, zinc acetate, zinc citrate, zinc iodide, zinc chloride, zinc perchlorate, zinc bis(trifluoromethanesulfonyl)imide, zinc nitrate, zinc phosphate, zinc triflate, zinc tetrafluoroborate, and zinc bromide.

The electrolyte may include a gelling agent. Gelling agent and gel forming agent is a gelling or thickening agent that increases the viscosity of an aqueous solution. The gelling agent may be present in the electrolyte in an amount between 0.01% and 20% of the weight of the electrolyte. The gelling agent may be selected from a group of gelling agents including xanthan gum, cellulose nanocrystals, fumed silica, colloidal silica, carboxy methyl cellulose, gelatin, alginate salts, agar, pectin, talc, sulfonate salts, casein, collagen, albumin, organosilicones, poly acrylic acid (or poly acrylate salts), and poly vinyl alcohol.

The separator 3 is wetted by the electrolyte. The separator 3 may be soaked by the electrolyte. The separator 3 is positioned in the cell 100 such that the separator 3 prevents the negative electrode 10 and positive electrode 20 from making physical contact with each other. The separator may be disposed between the negative electrode 10 and the positive electrode 20. The separator 3 is a thin separator. The thin separator may have a thickness on the order of microns. The separator 3 may be less than 200 μm thick.

The separator 3 may include a woven or non-woven material that is wetted by the electrolyte. The woven or non-woven material may be electrically insulating.

The separator 3 may include particles embedded in a polymeric matrix of textile fibers. In an embodiment, the particles are ceramic. In another embodiment, the particles are glass. The fibers of the separator 3 may be coated with ceramic or glass.

The separator 3 may be microporous. The microporous separator may have an average pore size of less than 1 μm.

The cell 100 may be manufactured using a standard process used in Li-ion battery manufacturing. For example, the cell 100 may be manufactured using a roll-to-roll electrode coatings onto metal foil current collectors, spiral winding of jelly rolls, stacking of electrodes, winding and compressing jelly rolls to produce prismatic, pouch, or cylindrical cells, or the like.

The secondary electrochemical cell 100 may be easy to manufacture. The use of a metal foil as the negative electrode current collector 1 and positive electrode current collector 5 having a relatively thin coating of electrochemically active material (e.g. zinc metal layer 2, active material layer 4) promotes ease-of-manufacture for the secondary cell 100. The thin film coatings allow for electrodes 10, 20 to be manufactured using similar methods to those employed in the manufacture of lithium-ion battery electrodes. Further, the electrodes 10, 20 are flexible enough to be assembled into cell formats commonly employed by lithium-ion batteries.

The secondary electrochemical cell 100 may have an extended cycle life compared to conventional zinc secondary cells. The extended cycle life may be into the several hundred or thousands of cycles. The secondary electrochemical cell 100 includes several design features that may have a positive effect on the plating and stripping of zinc during battery cycling and, consequently, a positive effect on the cycle life.

In an embodiment, the cell 100 includes a thin film electrode stack configuration where the negative electrode 10 includes a current collector 1 which is coated on both sides by a layer of zinc metal 2, the separator 3 which is soaked in electrolyte and prevents the negative electrode 10 and positive electrode 20 from contacting each other, and the positive electrode 20 which includes an active layer 4 which is coated on both sides of the current collector 5.

The cell 100 may be particularly advantageous. The cell 100 may incorporate a number of design features to extend the cycle life of the cell 100. The cell 100 may have an improved cycle life over conventional zinc ion batteries. In some cases, the cell 100 may have a cycle life into several hundred or thousands of cycles. The cell 100 may incorporate a number of design features to promote ease of manufacturing.

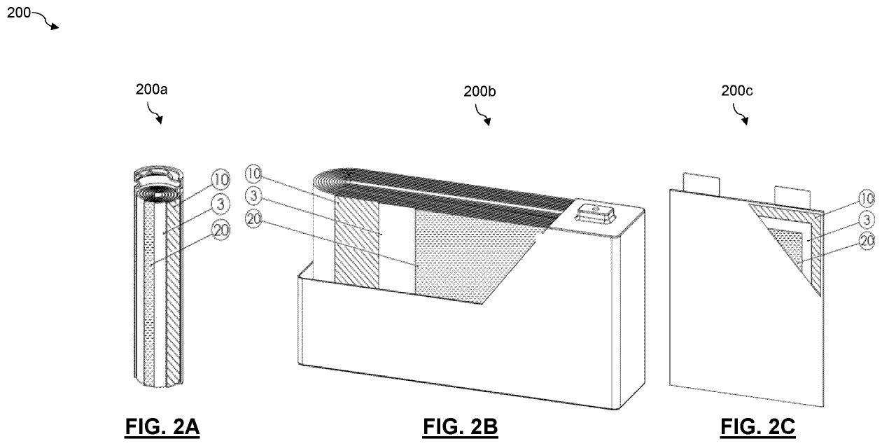

Referring now to FIG. 2, shown therein are cross-section views of a plurality of possible cell formats 200 for a zinc metal secondary cell (for example, secondary cell 100 of FIG. 1), according to embodiments.

Each of the cell formats/configurations 200 includes a plurality of layers. The plurality of layers may be stacked or rolled. A layer includes a negative electrode 10, a positive electrode 20, and a separator 3. The separator 3 is positioned or disposed between the negative and positive electrodes 10, 20.

FIG. 2A shows a cylindrical cell format 200a, according to an embodiment. In the cylindrical cell format 200a, the electrodes 10, 20 are spiral wound into a “jelly-roll”.

FIG. 2B shows a prismatic cell format 200b, according to an embodiment. The prismatic cell format 200b includes a rigid case where the electrodes 10, 20 are rolled and compressed into a “flattened jelly-roll”.

FIG. 2C shows a pouch cell format 200c, according to an embodiment. The pouch cell format 200c includes the electrodes 10, 20 in a stacked configuration. The electrodes 10, 20 may be cut into sheets and stacked. It should be noted that both the prismatic cell format 200b and the pouch cell format 200c may contain either wound (rolled) electrodes or stacks.

In some cases, the cycle life of a secondary cell (e.g. secondary cell 100 of FIG. 1) can be extended by limiting the areal capacity of cycled zinc.

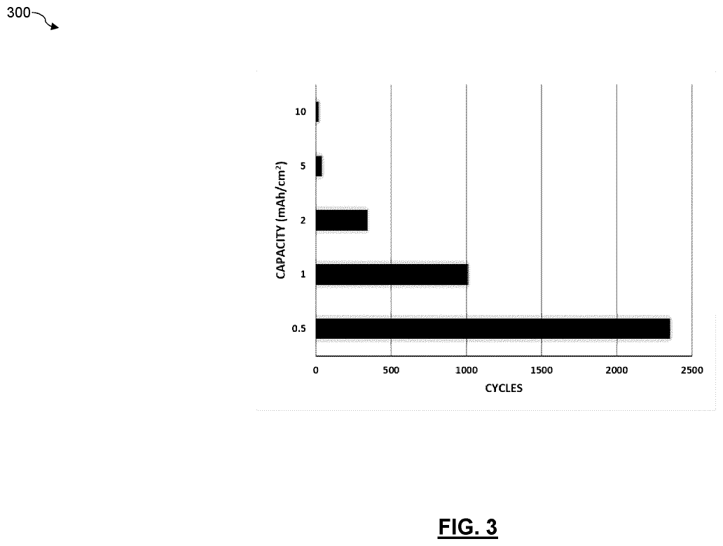

Referring now to FIG. 3, shown therein is a graph 300 illustrating the cycle life of zinc metal before failure due to internal short circuits in Zn∥Ti cells. The signature for this failure mode is overcharge when the stripping capacity exceeded the plating capacity. In these cells, zinc was plated onto a Ti plate at 5 mA/cm² to different areal capacities then subsequently stripped at 5 mA/cm² to a voltage of 0.7 V. The electrolyte was 1 M ZnSO₄ (pH˜5) for all of these cells.

Over 2000 cycles (2353) can be achieved if the plated zinc capacity is limited to 0.5 mAh/cm². When 10 mAh/cm² of zinc is plated and subsequently stripped from a titanium electrode surface, only 14 cycles were achieved. There is a trade-off between limiting the cycling capacity to low values to extend the cycle life and the resulting low practical energy density (Wh/kg or Wh/L) of the cell due to a lower active/inactive component ratio. Optimal areal capacity per each side of the positive electrode is about 2 mAh/cm² to 10 mAh/cm² to get a high energy density while maintaining a long cycle life.

In some cases, the cycle life of a secondary zinc-ion cell (e.g. secondary cell 100 of FIG. 1) can be extended by including a gelled electrolyte.

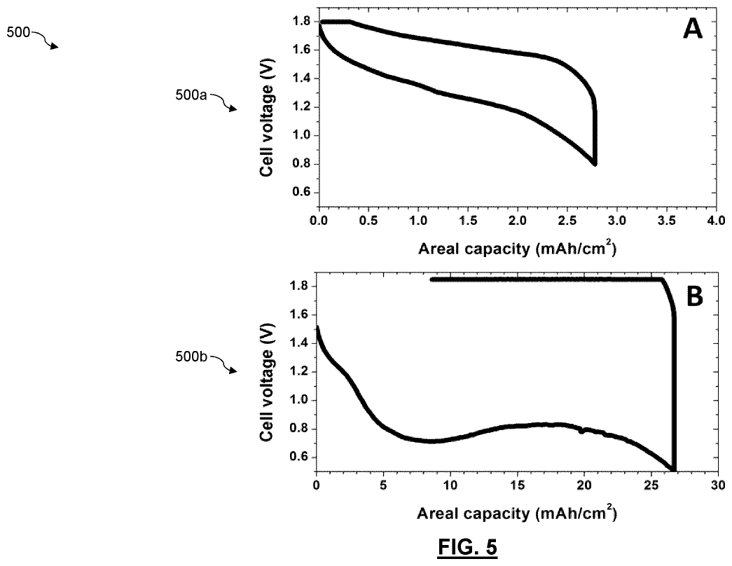

Referring now to FIG. 5, shown therein is a graph 500 summarizing the effect of gelled electrolytes in zinc (Zn∥Zn) symmetrical cells, according to an embodiment. Different electrolyte gel forming agents for plating and stripping of zinc metal electrodes (e.g. electrode 10 of FIG. 1) were tested. Zinc symmetrical cells were used as an accelerated test for cell failure.

Graph 400a shows an example voltage vs. time plot for a cell containing an electrolyte with 1 M ZnSO₄ dissolved in 1 wt % xanthan gum/water gel. Arrow 404 indicates the point when the cell suffered an internal short circuit due to the connection of zinc metal from the two electrodes originally separated by a layer of glass fiber.

Graph 400b shows a plot of a cycle number for different types of gel forming agents. The cycle number shown in graph 400b is the number of cycles achieved before an internal short circuit occurred. Gelled electrolytes demonstrated a ˜2×-˜4× improvement in the cycle life of these cells. Therefore, gel forming agents which increase the viscosity of the electrolyte can be used to improve the cycle life of zinc-ion batteries (e.g. cell 100 of FIG. 1).

### Examples

Secondary cells of the present disclosure (e.g. cell 100 of FIG. 1) use a thin film electrode cell format (e.g. cell formats 200a, 200b, 200c of FIG. 2). The thin film electrode cell format is attractive from a manufacturing standpoint due to its relative ease of manufacture. The performance of thin film electrodes may also be preferred as compared to thick electrodes.

Referring now to FIG. 5, shown therein is a voltage profile 500 for a first cycle of a thin film electrode 500a and a thick electrode 500b. The thin film electrode and the thick electrode were each cycled at 0.6 mA/cm² in 1 M ZnSO₄+0.1 M MnSO₄ dissolved in water electrolyte.

The thin film electrode 500a comprises electrolytic manganese dioxide (“EMD”) coated on a roughened Ni foil current collector which is 15 micrometers thick, providing a total electrode thickness of approximately 100 micrometers.

The thick electrode 500b comprises EMD having a current collector comprising a stainless-steel grid (700 micrometers thick), providing a total electrode thickness of 1.5 mm. Although the thick electrode 500b provides an areal capacity approximately 10 times higher than the areal capacity of the thin film electrode (27 mAh/cm² vs. 2.8 mAh/cm²), there is a massive overpotential due to kinetic (ionic diffusion) limitations in the thick electrode 500b.

The thin electrode 500a has an average discharge voltage of ˜1.3 V. The thick electrode 500b has an average discharge voltage of only ˜0.8 V. The thick electrode 500b could not be recharged and reached the upper voltage cut-off of 1.8 V almost immediately.

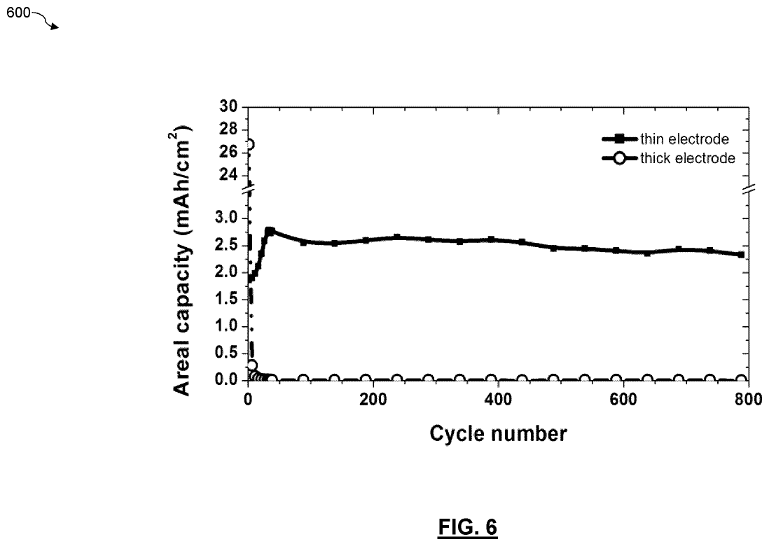

Referring now to FIG. 6, shown therein is a graph 600 showing a cycling performance for the two Zn∥EMD cells of FIG. 5 (500a, 500b). The cycling performance is represented by areal capacity (mAh/cm²) as a function of the cycle number. The thin film electrode 500a cycled for approximately 800 cycles. The thick electrode 500b only discharged once.

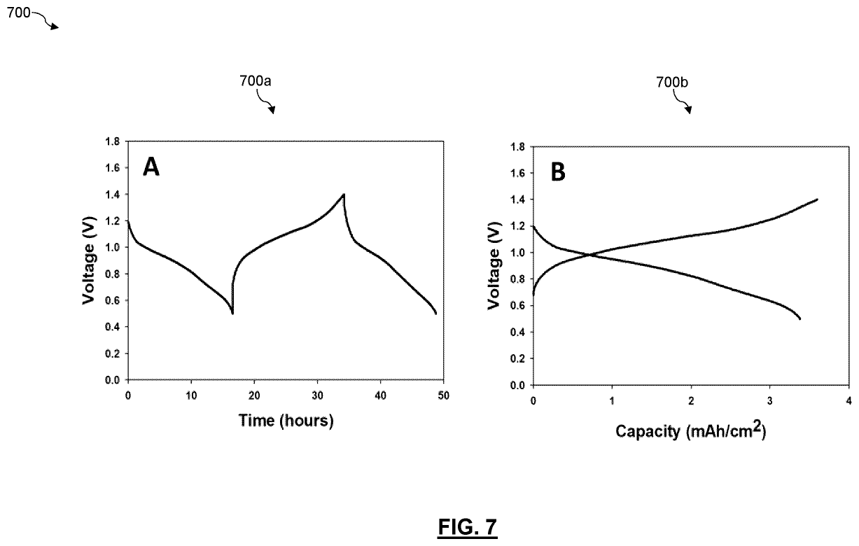

Referring now to FIG. 7, shown therein is a graph 700 of an example of a first cycle for a cell (e.g. cell 100 of FIG. 1), according to an embodiment. The cell was prepared using a zinc metal negative electrode (Zn foil=30 μm) (e.g. negative electrode 10 of FIG. 1), a separator of paper (160 μm) (e.g. separator 3 or FIG. 1) soaked in an electrolyte of 1 M ZnSO₄/water, and a positive electrode (e.g. positive electrode 20 of FIG. 1) made from an active coating (e.g. active material 4 of FIG. 1) of Zn_{0.25}V₂O₅.nH₂O on a roughened Ni foil current collector (15 μm) (e.g. current collector 5 of FIG. 1).

An areal capacity of about 3.5 mAh/cm² was achieved. Using the relationship between the density of zinc metal (7.14 g/cm³) and the gravimetric capacity of zinc (820 mAh/g), 1.7 μm of zinc is cycled per 1 mAh/cm² areal capacity. Using dense zinc foil as the negative electrode, this equates to a cycled zinc thickness of 5.95 μm in this cell per face of the electrode (e.g. zinc metal layer 2 of FIG. 1). If this foil was used as a doubled sided electrode (e.g. negative electrode 10 of FIG. 1), the excess zinc could act as a current collector (e.g. current collector 1 of FIG. 1) and would equal ˜18.1 μm.

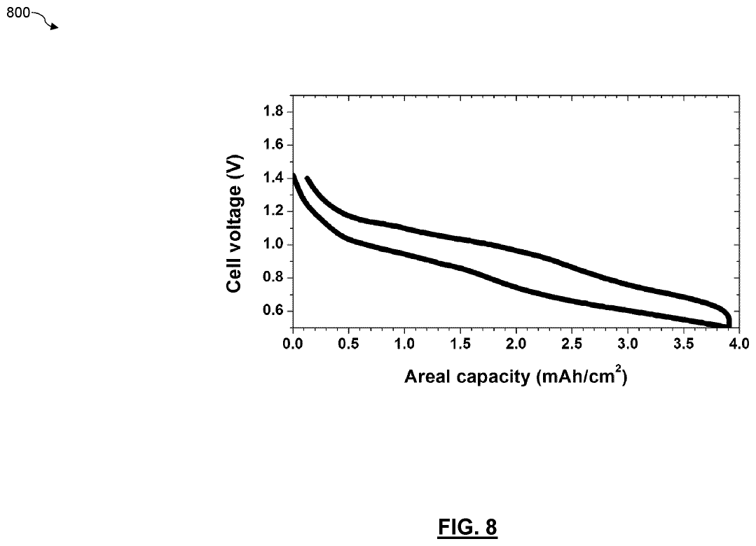

Referring now to FIG. 8, shown therein is a graph 800 of an example of a first cycle for a cell (e.g. cell 100 of FIG. 1), according to an embodiment. The cell was prepared using a zinc metal negative electrode (e.g. negative electrode 10 of FIG. 1) including zinc (e.g. zinc metal layer 2 of FIG. 1) electroplated onto a 25 μm copper foil current collector (e.g. current collector 1 or FIG. 1), and a positive electrode (e.g. positive electrode 20 of FIG. 1) made from an active coating (e.g. active material 4 of FIG. 1) of NaₓV₂O₅(SO₄)_{y}.nH₂O on a roughened Ni foil current collector (15 μm) (e.g. current collector 5 of FIG. 1).

In this example, the areal capacity reached 3.9 mAh/cm². An inert current collector was used for the negative electrode.

The cell included a separator (e.g. separator 3 of FIG. 1). The thickness and composition of the separator has proven important in the prevention of short circuits. Employing puncture resistant materials have proven to extend cycle life. In this example, the separator was a microporous silica-coated polyethylene separator (Entek, 175 μm) soaked in an electrolyte of 1 M ZnSO₄/water.

The following paragraphs describe the experimental methods used herein.

All electrochemical cells were assembled using a homemade plate design comprising a rubber gasket sandwiched between two acrylic plates. The acrylic plates were bolted together and housed the electrode stack (negative/separator/positive). The electrode stack was compressed together between Ti plates by external screws (torque of 2 in.-lb) which also served as electrical connections.

Zn∥Ti cells (e.g. FIG. 3) were prepared using a piece of zinc foil (250 μm thick) as the negative electrode and a titanium plate as the positive electrode. The piece of zinc was 5.5 cm×5.5 cm and the titanium was 4 cm×4 cm. The separator was a single piece of glass fiber filter membrane (˜300 μm thick). The current density applied was 5 mA/cm² (based off of the titanium electrode=16 cm²) and 5 mAh/cm² of zinc capacity was plated onto titanium. The zinc was subsequently stripped from the titanium to a voltage cut-off of 0.7 V. The electrolyte was 1 M ZnSO4 dissolved in water (pH˜5) which was added to the separator in ˜3 mL volumes.

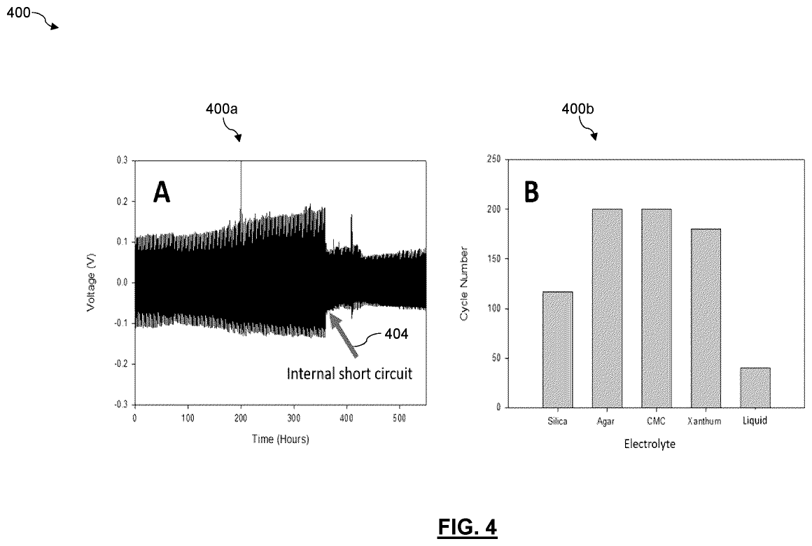

Zn∥Zn symmetric cells (e.g. FIG. 4) were prepared using two pieces of zinc foil (30 μm thick) as both the negative and positive electrodes. One piece of the zinc was 5.5 cm×5.5 cm and the other was 5 cm×5 cm. The separator was a single piece of glass fiber filter membrane (˜300 μm thick). The current density applied was 5 mA/cm² (based off of the smaller electrode=25 cm²) and the cycling capacity was 5 mAh/cm². The electrolytes tested were added to the separator in ˜3 mL volumes. The electrolytes tested were based on 1 M ZnSO₄ dissolved in water with and without the following gel forming agents: 1 wt. % agar, 1 wt. % xanthan gum, 10 wt. % fumed silica particles, and 4 wt. % carboxymethylcellulose (CMC).

The zinc-ion cells (e.g. zinc ion cells shown in FIGS. 5 to 8) were assembled using a zinc negative electrode, 5.5 cm×5.5 cm), a separator with ˜3 mL of electrolyte, and a positive electrode (5 cm×5 cm) consisting of a coating of active material on a current collector.

The positive electrode of the cell 500a shown in FIG. 5 was prepared by casting a slurry of electrolytic manganese dioxide (EMD, Tronox), Vulcan XC72 carbon black (Cabot Corp.), and polyvinylidene fluoride (PVDF) binder (HSV1800, Arkema) in N-methyl-2-pyrrolidone (NMP, Sigma Aldrich) solvent in the weight ratio of 93.5:4:2.5 onto a sheet of roughened Ni foil current collector (Targray, 15 μm thick). After casting, the electrode was dried at 80° C. for 20 minutes under air flow and then at 120° C. under partial vacuum for 2 hours. The electrolyte used in this cell was 1 M ZnSO₄+0.1 M MnSO₄ in water. The separator used was paper filter (160 μm thick). The zinc negative electrode was a piece of zinc foil (30 μm thick, Linyi Gelon LIB Co., Ltd.). The cell was cycled at 0.6 mA/cm² between 0.8 V and 1.8V.

The positive electrode of the cell 500b shown in FIG. 5 was prepared by spreading a dough of electrolytic manganese dioxide (EMD, Tronox), Vulcan XC72 carbon black (Cabot Corp.), and agar gel with a small amount of water in the weight ratio of 88:10:2 onto a stainless-steel grid (20 mesh, 700 μm thick, McMaster Carr). After casting, the electrode was calendared to a thickness of 1.5 mm. The electrolyte used in this cell was 1 M ZnSO₄+0.1 M MnSO₄ in water. The separator used was glass fiber filter membrane (˜300 μm thick). The zinc negative electrode was a piece of zinc foil (80 μm thick, Linyi Gelon LIB Co., Ltd.). The cell was cycled at 2.0 mA/cm² between 0.5 V and 1.8V.

The positive electrode of the cell shown in FIG. 7 was prepared by casting a slurry of synthesized Zn_{0.25}V₂O₅.nH₂O, Super C45 carbon black (Timcal), and polyvinylidene fluoride (PVDF) binder (HSV900, Arkema) in N-methyl-2-pyrrolidone (NMP) solvent in the weight ratio of 93.5:4:2.5 onto a sheet of roughened Ni foil (15 μm thick, Targray). After casting, the electrode was dried at 80° C. under partial vacuum for 2 hours and then calendared. The electrolyte used in this cell was 1 M ZnSO₄ in water. The separator used was a piece of paper filter (160 μm thick). The zinc negative electrode was a piece of zinc foil (30 μm thick, Linyi Gelon LIB Co., Ltd.). Briefly, the Zn_{0.25}V₂O₅.nH₂O was synthesized by dissolving V₂O₅ in a 0.1 M ZnCl₂ solution with 30 wt. % H₂O₂. The mixture was aged for 1 day, and then the solid product was filtered and washed with deionized water. Finally, the product was dried overnight in a vacuum oven at 80° C. The cell was cycled at 0.2 mA/cm² between 0.5 V and 1.4V.

The positive electrode of the cell shown in FIG. 8 was prepared by casting a slurry of synthesized NaₓV₂O₅(SO₄)_{y}.nH₂O, Vulcan XC72 carbon black (Cabot Corp.), and polyvinylidene fluoride (PVDF) binder (HSV1800, Arkema) in N-methyl-2-pyrrolidone (NMP, Sigma Aldrich) solvent in the weight ratio of 93.5:4:2.5 onto a sheet of roughened Ni foil current collector (Targray, 15 μm thick). After casting, the electrode was dried at 80° C. for 20 minutes under air flow and then at 120° C. under partial vacuum for 2 hours. The electrolyte used in this cell was 1 M ZnSO₄ in water. The separator used was a microporous silica-coated polyethylene separator (Entek, 175 μm thick). The zinc negative electrode was a piece of zinc electroplated (30 μm thick) onto a copper foil current collector (25 μm thick, McMaster Carr). Briefly, the NaₓV₂O₅(SO₄)_{y}.nH₂O was synthesized by acidifying a solution of NaVO₃ with H₂SO₄ and allowing the mixture to react at a boil for 20 minutes. The precipitate was then filtered and dried in air at 60° C. overnight. The cell was cycled at 0.6 mA/cm² between 0.5 V and 1.4V.

While the above description provides examples of one or more apparatus, methods, or systems, it will be appreciated that other apparatus, methods, or systems may be within the scope of the claims as interpreted by one of skill in the art.

1. A secondary electrochemical cell for storing and delivering electrical energy, the secondary electrochemical cell comprising:
a zinc metal negative electrode having a thickness less than 500 micrometers, comprising:
a negative electrode current collector; and
a zinc metal layer applied to the negative electrode current collector;
a positive electrode having a thickness less than one millimeter, comprising:
a positive electrode current collector; and
an active material layer applied to the positive electrode current collector;
wherein the active material layer electrochemically reacts reversibly with Zn²⁺ cations;
an aqueous electrolyte ionically coupling the negative electrode to the positive electrode; and
a separator having a thickness less than 200 micrometers disposed between the negative electrode and the positive electrode, wherein the separator is wetted by the aqueous electrolyte;
wherein the zinc metal layer has an areal capacity greater than an areal capacity of the positive electrode; and
wherein the zinc metal negative electrode has a first face and a second face, and wherein the areal capacity of the zinc metal layer is greater than or equal to 1 mAh/cm² on each of the first face and the second face of the negative electrode.

2-3. (canceled)

4. The secondary electrochemical cell of claim 1, wherein the negative electrode current collector has a thickness less than or equal to 50 μm,

5-7. (canceled)

8. The secondary electrochemical cell of claim 1, wherein the aqueous electrolyte comprises a zinc salt dissolved in water.

9-10. (canceled)

11. The secondary electrochemical cell of claim 8, wherein the zinc salt is selected from a group consisting of zinc sulfate, zinc acetate, zinc citrate, zinc iodide, zinc chloride, zinc perchlorate, zinc bis(trifluoromethanesulfonyl)imide, zinc nitrate, zinc phosphate, zinc triflate, zinc tetrafluoroborate, and zinc bromide.

12. The secondary electrochemical cell of claim 1, wherein the aqueous electrolyte has a pH value between 4 and 6.

13. The secondary electrochemical cell of claim 1, wherein the aqueous electrolyte comprises a gelling agent for increasing the viscosity of the aqueous electrolyte.

14-17. (canceled)

18. The secondary electrochemical cell of claim 1, wherein the separator comprises ceramic or glass particles embedded in a polymeric matrix of textile fibers.

19-23. (canceled)

24. The secondary electrochemical cell of claim 1, wherein the positive electrode has a first face and a second face, and wherein the storage capacity per electrode area is between 1 mAh/cm² and 10 mAh/cm² on each of the first face and the second face of the positive electrode.

25-27. (canceled)

28. The secondary electrochemical cell of claim 1, wherein the positive electrode current collector has a thickness less than or equal to 50 μm.

29-30. (canceled)

31. A method of forming a secondary electrochemical cell, the method comprising:
providing a zinc metal negative electrode having a thickness less than 500 micrometers and a positive electrode having a thickness less than one millimeter, wherein:
the zinc metal negative electrode comprises:
a negative electrode current collector; and
a zinc metal layer applied to the negative electrode current collector;
the positive electrode comprises:
a positive electrode current collector; and
an active material layer applied to the positive electrode current collector;
wherein the active material layer electrochemically reacts reversibly with Zn²⁺ cations;
ionically coupling the negative electrode to the positive electrode via an aqueous electrolyte; and
disposing a separator having a thickness less than 200 micrometers between the negative electrode and the physical electrode, wherein the separator is wetted by the aqueous electrolyte;
wherein the zinc metal layer has an areal capacity greater than an areal capacity of the positive electrode; and
wherein the zinc metal negative electrode has a first face and a second face, and wherein the areal capacity of the zinc metal layer is greater than or equal to 1 mAh/cm² on each of the first face and the second face of the negative electrode.

32-33. (canceled)

34. The method of claim 31, wherein the negative electrode current collector has a thickness less than or equal to 50 μm.

35. (canceled)

36. The method of claim 35, wherein the zinc metal layer is deposited onto the negative electrode current collector using:
a slurry casting process; or
a rolling of a paste dough process, the paste dough comprising the zinc metal layer.

37. (canceled)

38. The method of claim 31, wherein the aqueous electrolyte comprises a zinc salt dissolved in water.

39-40. (canceled)

41. The method of claim 38, wherein the zinc salt is selected from a group consisting of zinc sulfate, zinc acetate, zinc citrate, zinc iodide, zinc chloride, zinc perchlorate, zinc bis(trifluoromethanesulfonyl)imide, zinc nitrate, zinc phosphate, zinc triflate, zinc tetrafluoroborate, and zinc bromide.

42. The method of claim 31, wherein the aqueous electrolyte has a pH value between 4 and 6.

43-53. (canceled)

54. The method of claim 31, wherein the positive electrode has a first face and a second face, and wherein the storage capacity per electrode area is between 1 mAh/cm² and 10 mAh/cm² on each of the first face and the second face of the positive electrode.

55-57. (canceled)

58. The method of claim 31, wherein the positive electrode current collector has a thickness less than or equal to 50 μm.

59. The method of claim 31, wherein the active material layer is deposited onto the positive electrode current collector using:
a slurry casting process; or
a rolling of a paste dough process, the paste dough comprising the active metal layer.

60. (canceled)

61. The method of claim 31, further comprising controlling a pH value of the aqueous electrolyte between 4 and 6.

62. Fabricating a rechargeable battery by assembling a plurality of secondary electrochemical cells formed according to the method of claim 31 into either a stacked configuration or a rolled configuration.
